(19) United States
(12) Patent Application Publication
(10) Pub. No.: US 2026/0124909 A1
(43) Pub. Date: May 7, 2026

(54) UNIVERSAL PICKUP TUBE AND RETURN SYSTEM

(71) Applicant: SuperTanks LLC, Idaho Falls, ID (US)

(72) Inventors: James E. Patience, Idaho Falls, ID (US); Woodruff D Smith, Idaho Falls, ID (US)

(21) Appl. No.: 19/375,313

(22) Filed: Oct. 31, 2025

Related U.S. Application Data
(60) Provisional application No. 63/715,924, filed on Nov. 4, 2024.

(51) Int. Cl. B60K 15/073; B60K 15/03

(52) U.S. Cl. CPC B60K 15/073; B60K 2015/0348

(57) ABSTRACT

A universal pickup tube and return system is provided. The system includes a pickup tube with a pickup fitting coupled to the first end, configured as a universal fitting for vehicle pickup fuel lines. A return fitting couples to the vehicle's return fuel line. The pickup tube inserts into the replacement fuel tank's pickup insert with the pickup fitting extending from the top. The return fitting couples to the tank's return insert for fuel return. The pickup tube extends to the tank's lowest portion to draw fuel as levels drop. Both fittings are compatible with aftermarket high-pressure fuel systems, providing plug and play installation without requiring custom components.

### CROSS-REFERENCE TO RELATED APPLICATIONS

This application claims priority U.S. Provisional Application No. 63/715,924, filed November 4, 2024, the disclosure of which is hereby incorporated entirely herein by reference.

### TECHNICAL FIELD

The present disclosure relates to fuel tank systems for vehicles, and more particularly to a universal pickup tube and return system for replacement fuel tanks that provides compatibility with high-pressure fuel systems and aftermarket fuel system components.

### State of the Art

Fuel systems in modern vehicles, particularly those equipped with diesel engines and fuel injection systems, commonly incorporate pickup tubes and return lines to facilitate proper fuel delivery and circulation. These components work together to draw fuel from the tank and return excess fuel back to the tank, maintaining optimal fuel pressure and system performance.

Many vehicle owners seek to increase their fuel capacity by installing replacement fuel tanks that offer greater storage volume than the original equipment manufacturer tanks. These aftermarket replacement tanks provide extended range capabilities, which can be particularly beneficial for commercial vehicles, recreational vehicles, and long-distance travel applications.

However, replacement fuel tanks typically do not include integrated pickup tubes or return systems that are compatible with the wide variety of fuel systems found across different vehicle makes and models. This creates challenges for vehicle owners who wish to upgrade their fuel capacity while maintaining proper fuel system functionality.

The situation becomes more complex when considering high-pressure fuel systems and aftermarket fuel system components. These systems, which may include various brands and configurations of fuel pumps and filtration systems, often have specific connection requirements and flow characteristics that differ from standard fuel systems.

Conventional approaches to addressing these compatibility issues often involve custom fabrication or modification of components for each specific vehicle and fuel system combination. This process can be time-consuming, costly, and may require specialized knowledge or equipment that is not readily available to all installers or end users.

Additionally, the installation of pickup tubes and return systems in replacement tanks typically involves drilling holes and making permanent modifications to the tank structure. These modifications must be performed carefully to maintain the integrity of the tank while providing secure, leak-free connections for the fuel system components.

Accordingly, there is a need for an improved universal pickup tube and return system for utilization in replacement fuel tanks.

### SUMMARY OF THE INVENTION

According to an aspect of the present disclosure, a universal pickup tube and return system for a replacement fuel tank is provided. The system comprises a pickup tube having a first end and a second end. A pickup fitting is coupled to the first end of the pickup tube, with the pickup fitting being a universal fitting configured to couple to a pickup fuel line of a vehicle. A return fitting is configured to couple to a return fuel line of the vehicle. The pickup tube is configured to be inserted into a pickup insert of the replacement fuel tank with the pickup fitting extending from a top side of the replacement fuel tank, and the return fitting is configured to be coupled to a return insert of the replacement fuel tank to act as a fuel return.

According to another aspect of the present disclosure, a replacement fuel tank system is provided. The system comprises a replacement fuel tank having a tank body with a pickup insert and a return insert disposed on a top portion of the tank body. A pickup tube is inserted into the pickup insert and extends toward a bottom portion of the tank body. A pickup fitting is coupled to an end of the pickup tube and extends from the top portion of the replacement fuel tank at the pickup insert, with the pickup fitting being a universal fitting configured to couple to a pickup fuel line of a vehicle. A return fitting is coupled to the return insert, with the return fitting being a universal fitting configured to couple to a return fuel line of the vehicle.

According to a further aspect of the present disclosure, a method of installing a universal pickup tube and return system in a replacement fuel tank is provided. The method comprises drilling a hole in a pickup insert located on a top portion of the replacement fuel tank. A pickup tube is inserted through the drilled hole such that the pickup tube extends toward a bottom portion of the replacement fuel tank. A pickup fitting is coupled to an end of the pickup tube that extends from the top portion of the replacement fuel tank, with the pickup fitting being a universal fitting configured to couple to a pickup fuel line of a vehicle. A return fitting is coupled to a return insert on the top portion of the replacement fuel tank, with the return fitting being a universal fitting configured to couple to a return fuel line of the vehicle.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 illustrates a side view of a universal pickup tube system, according to an embodiment;

FIG. 2 illustrates a partial section perspective view of the universal pickup tube system coupled to a replacement tank, according to an embodiment; and

FIG. 3 illustrates a zoomed-in partial section perspective view of the universal pickup tube system coupled to the replacement tank, according to an embodiment.

### DETAILED DESCRIPTION OF EMBODIMENTS OF THE INVENTION

As discussed above, embodiments of the present invention relate to a universal pickup tube and return system for use with replacement fuel tanks that provides compatibility with high-pressure fuel systems and aftermarket fuel system components.

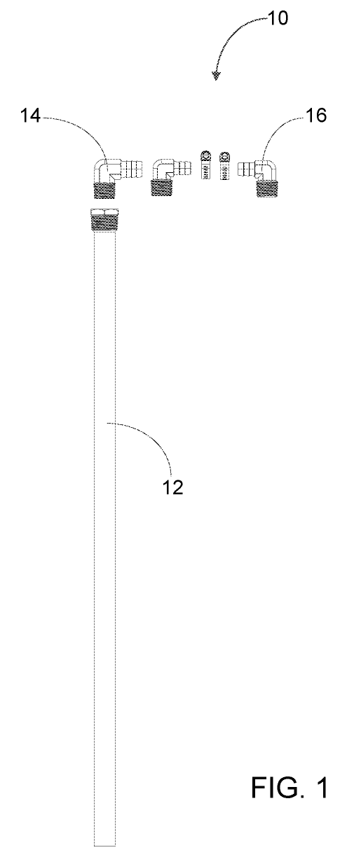

Referring to FIG. 1, a universal pickup tube system 10 may be configured as a comprehensive fuel system solution for replacement fuel tanks. The universal pickup tube system 10 may include a pickup tube 12 that extends vertically along the length of the system. The pickup tube 12 may have a first end and a second end, with the pickup tube 12 configured to facilitate fuel draw operations within a replacement fuel tank.

A pickup fitting 14 may be coupled to the first end of the pickup tube 12, with the pickup fitting 14 positioned at an upper end of the pickup tube 12. The pickup fitting 14 may be configured as a universal fitting that couples to a pickup fuel line of a vehicle. In some cases, the pickup fitting 14 may provide standardized connection capabilities that accommodate various vehicle fuel line configurations without requiring vehicle-specific modifications.

As further shown in FIG. 1, a return fitting 16 may be positioned adjacent to the pickup fitting 14 at an upper portion of the universal pickup tube system 10. The return fitting 16 may be configured to couple to a return fuel line of the vehicle and act as a fuel return component. The pickup fitting 14 and the return fitting 16 may be arranged in a substantially horizontal configuration at a top of the system, providing accessible connection points for fuel line attachment.

The pickup tube 12 may be configured to be inserted into a pickup insert of a replacement fuel tank with the pickup fitting 14 extending from a top side of the replacement fuel tank. In some cases, the return fitting 16 may be configured to be coupled to a return insert of the replacement fuel tank to act as a fuel return. The pickup tube 12 may include a coupler at the second end that connects to the pickup fitting 14, facilitating assembly and installation of the universal pickup tube system 10.

The universal pickup tube system 10 may be compatible with aftermarket high-pressure fuel systems including FASS and AirDog systems. In some cases, the universal pickup tube system 10 may provide compatibility with various high-pressure fuel system configurations commonly used in diesel vehicle applications. The replacement fuel tank may be configured as a Gen 7 XXL tank for particular vehicle models including Duramax diesel and Ford Power Stroke diesel trucks.

The universal pickup tube system 10 may be configured to provide a plug and play installation without requiring custom built components for individual vehicles. In some cases, the system may eliminate the need for vehicle-specific modifications or custom fabrication, allowing for standardized installation procedures across different vehicle platforms. The universal pickup tube system 10 may create a simplified installation process compared to conventional fuel system modifications that require drilling holes in tanks and using custom built components for each truck.

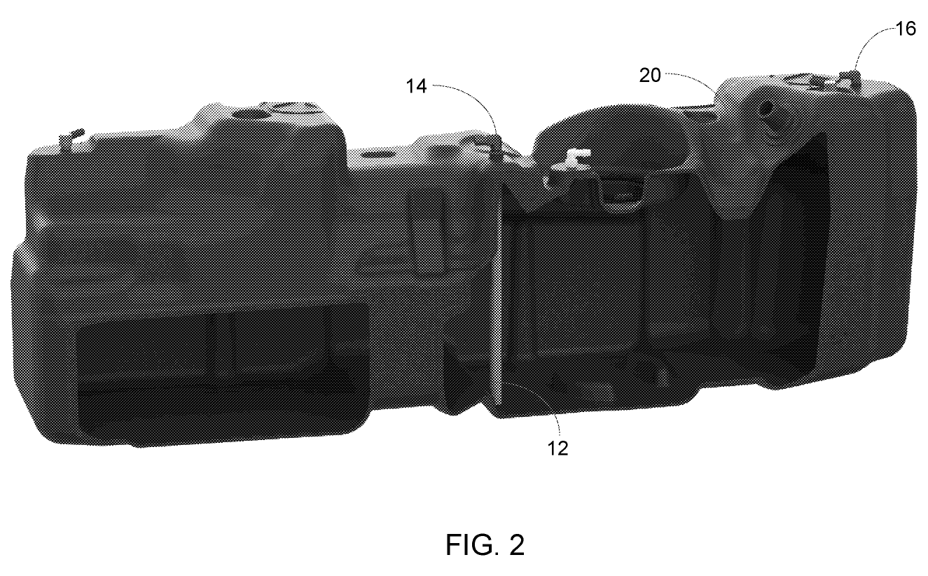

Referring to FIG. 2, a replacement tank 20 may be configured to receive the universal pickup tube and return system 10. The replacement tank 20 may include a tank body that provides a fuel storage volume for vehicle applications. In some cases, the replacement tank 20 may be constructed from High-Density Cross-Linked Polyethylene (XLHDPE) material, which may provide durability and chemical resistance for fuel storage applications.

As shown in FIG. 2, the pickup tube 12 may be inserted into the replacement tank 20 and may extend toward a bottom portion of the tank body. The pickup tube 12 may be configured to extend to a lowest portion of the replacement tank 20 to draw fuel as a fuel level drops within the tank body. In some cases, the pickup tube 12 may be positioned approximately 3 inches above the tank floor without touching the bottom surface of the replacement tank 20. This positioning may allow for fuel extraction while preventing contact with sediment or debris that may settle at the bottom of the replacement tank 20.

With continued reference to FIG. 2, the pickup fitting 14 may be positioned at a top portion of the replacement tank 20. The pickup fitting 14 may extend from the top side of the replacement tank 20 and may provide a connection point for coupling to a pickup fuel line of a vehicle. The pickup fitting 14 may be configured as a universal fitting that may accommodate various vehicle fuel line configurations without requiring custom components for individual vehicle applications.

The return fitting 16 may also be mounted on the top portion of the replacement tank 20, as illustrated in FIG. 2. The return fitting 16 may be configured to couple to a return fuel line of the vehicle and may act as a fuel return pathway. In some cases, both the pickup fitting 14 and the return fitting 16 may be configured for compatibility with aftermarket high-pressure fuel systems, including systems such as FASS and AirDog fuel systems. This compatibility may allow the replacement fuel tank system to function with high-performance fuel delivery applications that may require enhanced fuel flow rates and pressure capabilities.

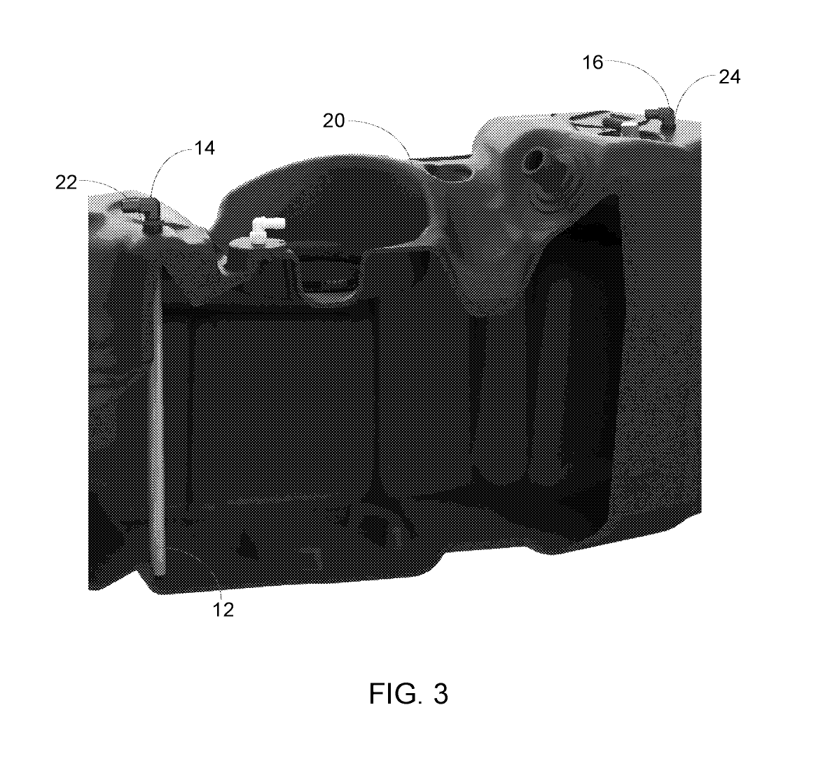

Referring to FIG. 3, a zoomed-in partial section perspective view reveals the detailed configuration of the universal pickup tube and return system coupled to replacement tank 20. The replacement tank 20 may include a pickup insert 22 and a return insert 24 positioned on a top portion of the tank body. In some cases, the pickup insert 22 and the return insert 24 may be positioned on a top surface of the replacement fuel tank to allow drilling access for installation of the pickup tube 12 and the return fitting 16.

As shown in FIG. 3, pickup tube 12 may extend through pickup insert 22, with pickup fitting 14 coupled to the pickup tube 12 at the pickup insert 22. The pickup fitting 14 may extend from the top portion of replacement tank 20, providing a connection point for vehicle fuel lines. Return fitting 16 may be coupled to return insert 24, creating a fuel return connection point on the top portion of the replacement tank 20.

The pickup insert 22 may be specifically located above a fuel trap within the tank body of replacement tank 20. This positioning may allow the pickup tube 12 to access fuel from the lowest portions of the tank as fuel levels drop during operation. The return insert 24 may be positioned to provide convenient access for return fuel lines from high-pressure fuel systems.

In some cases, the replacement tank system may include additional capabilities through accessory kits. The replacement tank 20 may be configured to work with a Fast Fill Vent Kit that enables filling by high-flow truck stop pumps without pressure buildup or spillage. This configuration may allow for rapid refueling at commercial truck stops.

The replacement tank system may also include a Transfer Pump Kit with a universal pump mounting bracket for drawing fuel to refuel other vehicles and equipment. The Transfer Pump Kit may enable users to draw fuel from the replacement tank 20 for use in other applications while maintaining a compact installation in the truck bed.

Referring further to FIG. 3, a method of installing a universal pickup tube and return system in a replacement fuel tank may be performed to provide a plug and play installation solution. The installation method may begin with drilling a hole in a pickup insert located on a top portion of the replacement fuel tank. The drilling process may utilize a progressive drilling technique that starts with a small pilot drill bit and gradually increases drill bit size to achieve a desired hole diameter. This progressive approach may help prevent damage to surrounding material and may provide better control over the final hole dimensions.

During the drilling operation, various techniques may be employed to catch plastic shavings and prevent debris from entering the replacement fuel tank. A system to catch plastic shavings may be set up before beginning the drilling step. In some cases, the step of setting up a system to catch plastic shavings comprises placing a rag inside the replacement fuel tank beneath a drilling location. The rag may be positioned to intercept falling debris during the drilling process. Additionally, grease may be applied on the drill bit to catch plastic shavings during drilling operations. The grease may help capture shavings as the drill bit cuts through the material, reducing the amount of debris that falls into the tank.

In some cases, a vacuum with a hose directed at the drilling site may be used to remove shavings during drilling. The vacuum hose may be positioned near the drilling location to actively suction away plastic debris as the hole is being formed. This technique may provide real-time debris removal and may further reduce contamination of the tank interior.

After the hole has been drilled to the appropriate size, the method may include trimming an inside edge of the drilled hole with a razor blade to ensure a flush fit with threads and remove rough edges. The trimming step may help create a smooth surface that facilitates proper threading and sealing of components. The razor blade may be used to carefully remove any burrs or irregular material around the hole perimeter.

Following the trimming operation, the method may include inserting a pickup tube through the drilled hole such that the pickup tube extends toward a bottom portion of the replacement fuel tank. The pickup tube may be positioned to extend to a lowest portion of the tank to enable fuel draw as fuel levels drop during operation.

The installation method may further include applying thread seal tape to threads of a pickup fitting before a coupling step. The thread seal tape may provide a leak-resistant seal between threaded components. After applying the thread seal tape, the method may include coupling the pickup fitting to an end of the pickup tube that extends from the top portion of the replacement fuel tank. The pickup fitting may be a universal fitting configured to couple to a pickup fuel line of a vehicle.

The method may also include coupling a return fitting to a return insert on the top portion of the replacement fuel tank. The return fitting may be a universal fitting configured to couple to a return fuel line of the vehicle. The return fitting may be installed using similar threading and sealing techniques as described for the pickup fitting.

After the trimming step and component installation, the method may include cleaning the replacement fuel tank to remove all plastic debris. Compressed air may be used to clean the replacement tank after drilling and trimming operations. The compressed air may be directed throughout the tank interior to dislodge and remove any remaining plastic shavings or debris that may have accumulated during the installation process. This cleaning step may help prevent contamination of the fuel system and may ensure proper operation of the installed components.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A universal pickup tube and return system for a replacement fuel tank, comprising:
a pickup tube having a first end and a second end;
a pickup fitting coupled to the first end of the pickup tube, the pickup fitting being a universal fitting configured to couple to a pickup fuel line of a vehicle; and
a return fitting configured to couple to a return fuel line of the vehicle, wherein the pickup tube is configured to be inserted into a pickup insert of the replacement fuel tank with the pickup fitting extending from a top side of the replacement fuel tank, and the return fitting is configured to be coupled to a return insert of the replacement fuel tank to act as a fuel return.

2. The universal pickup tube and return system of claim 1, wherein the pickup tube is configured to extend to a lowest portion of the replacement fuel tank to draw fuel as a fuel level drops.

3. The universal pickup tube and return system of claim 1, wherein the pickup fitting and the return fitting are configured for compatibility with aftermarket high-pressure fuel systems.

4. The universal pickup tube and return system of claim 1, wherein the pickup tube includes a coupler at the second end configured to connect to the pickup fitting.

5. The universal pickup tube and return system of claim 1, wherein the pickup insert and the return insert are positioned on a top surface of the replacement fuel tank.

6. The universal pickup tube and return system of claim 1, wherein the system is configured to provide a plug and play installation without requiring custom built components for individual vehicles.

7. A replacement fuel tank system, comprising:
a replacement fuel tank having a tank body with a pickup insert and a return insert disposed on a top portion of the tank body;
a pickup tube inserted into the pickup insert and extending toward a bottom portion of the tank body;
a pickup fitting coupled to an end of the pickup tube and extending from the top portion of the replacement fuel tank at the pickup insert, the pickup fitting being a universal fitting configured to couple to a pickup fuel line of a vehicle; and
a return fitting coupled to the return insert, the return fitting being a universal fitting configured to couple to a return fuel line of the vehicle.

8. The replacement fuel tank system of claim 7, wherein the pickup tube extends to a lowest portion of the tank body to draw fuel as a fuel level drops.

9. The replacement fuel tank system of claim 7, wherein the pickup fitting and the return fitting are configured for compatibility with aftermarket high-pressure fuel systems.

10. The replacement fuel tank system of claim 7, wherein the replacement fuel tank is constructed from High-Density Cross-Linked Polyethylene.

11. The replacement fuel tank system of claim 7, wherein the pickup insert and the return insert are positioned to allow drilling access for installation of the pickup tube and the return fitting.

12. The replacement fuel tank system of claim 11, wherein the pickup insert is located above a fuel trap within the tank body.

13. A method of installing a universal pickup tube and return system in a replacement fuel tank, comprising:
drilling a hole in a pickup insert located on a top portion of the replacement fuel tank;
inserting a pickup tube through the drilled hole such that the pickup tube extends toward a bottom portion of the replacement fuel tank;
coupling a pickup fitting to an end of the pickup tube that extends from the top portion of the replacement fuel tank, the pickup fitting being a universal fitting configured to couple to a pickup fuel line of a vehicle; and
coupling a return fitting to a return insert on the top portion of the replacement fuel tank, the return fitting being a universal fitting configured to couple to a return fuel line of the vehicle.

14. The method of claim 13, further comprising a step of setting up a system to catch plastic shavings during the drilling step to prevent debris from entering the replacement fuel tank.

15. The method of claim 14, wherein the step of setting up a system to catch plastic shavings comprises placing a rag inside the replacement fuel tank beneath a drilling location.

16. The method of claim 13, further comprising a step of applying thread seal tape to threads of the pickup fitting before the coupling step.

17. The method of claim 13, further comprising a step of trimming an inside edge of the drilled hole with a razor blade to ensure a flush fit with threads and remove rough edges.

18. The method of claim 17, further comprising a step of cleaning the replacement fuel tank to remove all plastic debris after the trimming step.
